(19) United States
(12) Patent Application Publication
(10) Pub. No.: US 2006/0105264 A1
(43) Pub. Date: May 18, 2006

(54) Process for preparing photosensitive outer layer using prepolymer with reactive groups and melamine formaldehyde crosslinking agent

(75) Inventors: Kenny-Tuan T. Dinh, Webster, NY (US); John F. Yanus, Webster, NY (US); Kathleen M. Carmichael, Williamson, NY (US); Markus R. Silvestri, Fairport, NY (US); Yuhua Tong, Webster, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/992,913

(22) Filed: Nov. 18, 2004

(51) Int. Cl. G03G 5/147

(52) U.S. Cl. 430/132; 430/66

(57) ABSTRACT

A process for preparing an overcoat for an imaging member having a substrate, a charge transport layer, and an overcoat positioned on the charge transport layer, and the process includes combining a prepolymer having a reactive group selected from the group consisting of hydroxyl, carboxylic acid and amide groups, a melamine formaldehyde crosslinking agent, an acid catalyst, and an alcohol-soluble small molecule to form an overcoat solution; and subsequently providing the overcoat solution onto the charge transport layer to form an overcoat layer.

### BACKGROUND

The processes described herein can be used to prepare photosensitive members or photoconductors useful in electrostatographic, including printers, copiers, other reproductive devices, and digital apparatuses. In specific embodiments, the process includes adding and reacting a prepolymer comprising a reactive group selected from the group consisting of hydroxyl, carboxylic acid, and amide groups, a melamine formaldehyde crosslinking agent, an acid catalyst, and an alcohol-soluble small molecule in order to prepare an outer coating for a photosensitive member.

Electrophotographic imaging members, including photoreceptors or photoconductors, typically include a photoconductive layer formed on an electrically conductive substrate or formed on layers between the substrate and photoconductive layer. The photoconductive layer is an insulator in the dark, so that electric charges are retained on its surface. Upon exposure to light, the charge is dissipated, and an image can be formed thereon, developed using a developer material, transferred to a copy substrate, and fused thereto to form a copy or print.

U.S. Pat. No. 5,702,854 to Schank et al. discloses an electrophotographic imaging member including a supporting substrate coated with at least a charge generating layer, a charge transport layer and an overcoating layer. The overcoating layer comprises a dihydroxy arylamine dissolved or molecularly dispersed in a crosslinked polyamide matrix. The overcoating layer is formed by crosslinking a crosslinkable coating composition including a polyamide containing N-methoxy methyl groups attached to amide nitrogen atoms, a crosslinking catalyst and a dihydroxy amine, and heating the coating to crosslink the polyamide.

U.S. Pat. No. 5,681,679 issued to Schank, et al. discloses a flexible electrophotographic imaging member including a supporting substrate and a resilient combination of at least one photoconductive layer and an overcoating layer. The at least one photoconductive layer comprises a hole transporting arylamine siloxane polymer and the overcoating comprising a crosslinked polyamide doped with a dihydroxy amine.

U.S. Pat. No. 6,004,709, issued to Renfer et al. discloses an allyloxypolyamide composition. The allyloxypolyamide is represented by a specific formula. The allyloxypolyamide may be synthesized by reacting an alcohol soluble polyamide with formaldehyde and an allylalcohol.

U.S. Pat. No. 5,976,744 issued to Fuller et al. discloses an electrophotographic imaging member including a supporting substrate coated with at least one photoconductive layer, and an overcoating layer. The overcoating layer includes hydroxy functionalized aromatic diamine and a hydroxy functionalized triarylamine dissolved or molecularly dispersed in a crosslinked acrylated polyamide matrix. The hydroxy functionalized triarylamine is a compound different from the polyhydroxy functionalized aromatic diamine.

U.S. Pat. No. 5,709,974 issued to Yuh et al. discloses an electrophotographic imaging member including a charge generating layer, a charge transport layer and an overcoating layer. The transport layer includes a charge transporting aromatic diamine molecule in a polystyrene matrix. The overcoating layer includes a hole transporting hydroxy arylamine compound having at least two hydroxy functional groups, and a polyamide film forming binder capable of forming hydrogen bonds with the hydroxy functional groups of the hydroxy arylamine compound.

U.S. Pat. No. 5,368,967 issued to Schank et al. discloses an electrophotographic imaging member comprising a substrate, a charge generating layer, a charge transport layer, and an overcoat layer comprising a small molecule hole transporting arylamine having at least two hydroxy functional groups, a hydroxy or multihydroxy triphenyl methane, and a polyamide film forming binder capable of forming hydrogen bonds with the hydroxy functional groups such as the hydroxy arylamine and hydroxy or multihydroxy triphenyl methane. This overcoat layer may be fabricated using an alcohol solvent. This electrophotographic imaging member may be used in an electrophotographic imaging process. Specific materials including ELVAMIDE® polyamide and N,N′-diphenyl-N,N′-bis(3-hydroxyphenyl)-(1,1′-biphenyl)-4,4′-diamine and bis-[2-methyl-4-(N-2-hydroxyethyl-N-ethyl-aminophenyl)]-phenylmethane are disclosed in this patent.

U.S. Pat. No. 4,871,634 to Limburg et al. discloses an electrostatographic imaging member containing at least one electrophotoconductive layer. The imaging member comprises a photogenerating material and a hydroxy arylamine compound represented by a certain formula. The hydroxy arylamine compound can be used in an overcoat with the hydroxy arylamine compound bonded to a resin capable of hydrogen bonding such as a polyamide possessing alcohol solubility.

U.S. Pat. No. 4,297,425 to Pai et al. discloses a layered photosensitive member comprising a generator layer and a transport layer containing a combination of diamine and triphenyl methane molecules dispersed in a polymeric binder.

U.S. Pat. No. 4,050,935 to Limburg et al. discloses a layered photosensitive member comprising a generator layer of trigonal selenium and a transport layer of bis(4-diethylamino-2-methylphenyl) phenylmethane molecularly dispersed in a polymeric binder.

U.S. Pat. No. 4,457,994 to Pai et al. discloses a layered photosensitive member comprising a generator layer and a transport layer containing a diamine type molecule dispersed in a polymeric binder, and an overcoat containing triphenyl methane molecules dispersed in a polymeric binder.

U.S. Pat. No. 4,281,054 to Horgan et al., discloses an imaging member comprising a substrate, an injecting contact or hole injecting electrode overlying the substrate, a charge transport layer comprising an electrically inactive resin containing a dispersed electrically active material, a layer of charge generator material, and a layer of insulating organic resin overlying the charge generating material. The charge transport layer can contain triphenylmethane.

U.S. Pat. No. 4,599,286 to Limburg et al. discloses an electrophotographic imaging member comprising a charge generation layer and a charge transport layer. The transport layer comprises an aromatic amine charge transport molecule in a continuous polymeric binder phase and a chemical stabilizer selected from the group consisting of certain nitrone, isobenzofuran, hydroxyaromatic compounds and mixtures thereof. An electrophotographic imaging process using this member is also described.

U.S. Pat. No. 5,418,107 to Nealey et al. discloses a process for fabricating an electrophotographic imaging member.

In some electrostatographic apparatuses, a spots blade, such as a polyurethane spots blade, is used to clean film and debris off the surface of the photoreceptor belt. There is no means of cleaning the edge of the spots blade during machine operation. Debris, removed from the photoreceptor belt, is supposed to fall off the edge of the blade and be caught by the cleaner brush. However, there is still the chance that a certain amount of debris stays at the interface of the spots blade and the photoreceptor. Once the blade wear increases and the tip pressure of the blade reduces, the debris can get trapped under the blade and scratch the photoreceptor. These scratches can be printable if the debris is hard. Hard debris includes a carrier bead or a toner agglomerate.

Therefore, there is a need for an overcoat on the photoreceptor that includes an anti-scratch material, which has been modified to have charge transporting properties. It is specifically desired to provide an overcoat which is resistant to hard scratches, such as those formed by carrier beads or toner agglomerates. In addition, it is desired to provide an overcoating with improved lateral charge migration (LCM), superior mechanical life including corona and flexing life, and excellent electrical properties.

### SUMMARY

Embodiments of the present invention include a process for preparing an overcoat for an imaging member, the imaging member comprising a substrate, a charge transport layer, and an overcoat positioned on the charge transport layer, wherein the process comprises a) combining a prepolymer comprising a reactive group selected from the group consisting of hydroxyl, carboxylic acid, and amide groups, a melamine formaldehyde crosslinking agent, an acid catalyst, and an alcohol-soluble small molecule to form an overcoat solution; and b) subsequently providing said overcoat solution onto the charge transport layer to form an overcoat layer.

Embodiments further include a process for preparing an overcoat for an imaging member, the imaging member comprising a substrate, a charge transport layer, and an overcoat positioned on the charge transport layer, wherein the process comprises a) combining a polyamide prepolymer, a melamine formaldehyde crosslinker, an acid acceptor, and an alcohol-soluble small molecule to form an overcoat solution; and b) subsequently providing said overcoat solution onto said charge transport layer to form an overcoat layer.

In addition, embodiments include a process for preparing an overcoat for an imaging member, the imaging member comprising a substrate, a charge transport layer comprising a polycarbonate and N,N′-diphenyl-N,N′-bis(3-methyl-phenyl)-(1,1′-biphenyl)-4,4′-diamine, and an overcoat positioned on the charge transport layer, wherein the process comprises a) combining a prepolymer comprising a reactive group selected from the group consisting of hydroxyl, carboxylic acid, and amide groups, a melamine formaldehyde crosslinking agent, an acid catalyst, and an alcohol-soluble small molecule to form an overcoat solution; and b) subsequently providing the overcoat solution onto the charge transport layer to form an overcoat layer.

### BRIEF DESCRIPTION OF THE DRAWINGS

For a better understanding of the present invention, reference may be had to the accompanying figure.

FIG. 1 is an illustration of a general electrostatographic apparatus using a photoreceptor member.

FIG. 2 is an illustration of an embodiment of a photoreceptor showing various layers.

FIG. 3 is demonstrate the effect of corona effluents on lateral charge migration for embodiments of the invention and the comparative formulation and is discussed in Example 11 below.

### DETAILED DESCRIPTION

The processes herein relate to processes for producing an overcoat having improved scratch resistance. The present processes include combining in solution a prepolymer comprising a reactive group selected from the group consisting of hydroxyl, carboxylic acid and amide groups, a melamine formaldehyde crosslinking agent, an acid catalyst, and an alcohol-soluble small molecule in order to prepare an outer coating for a photosensitive member. In embodiments, the prepolymer forms a polyamide. By heating the photosensitive member, the outer coating forms a crosslinked network on the outer surface.

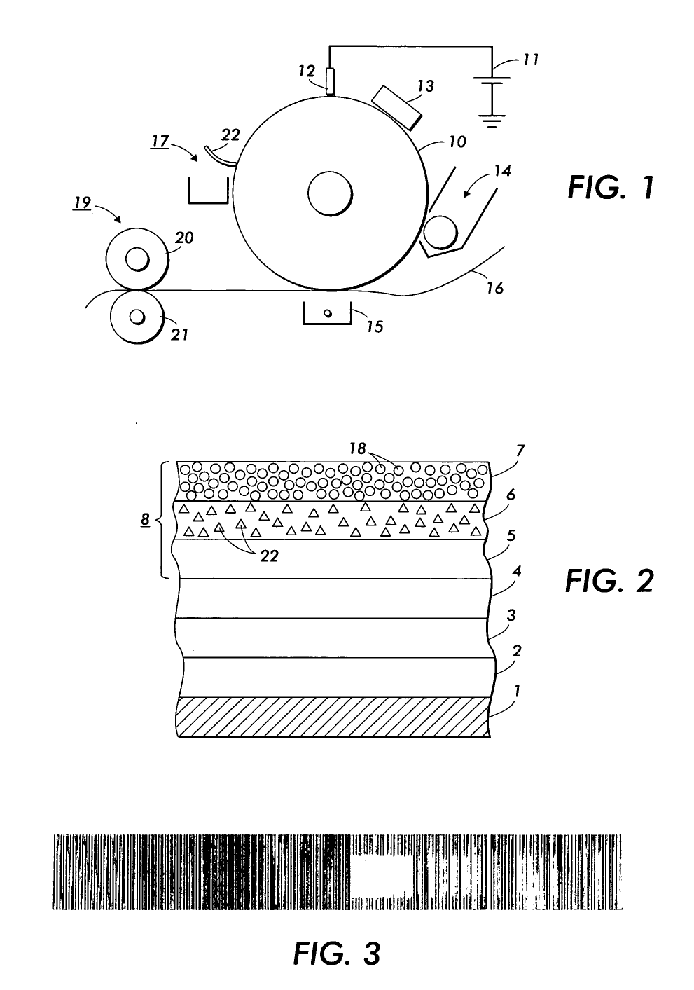

Referring to FIG. 1, in a typical electrostatographic reproducing apparatus, a light image of an original to be copied is recorded in the form of an electrostatic latent image upon a photosensitive member and the latent image is subsequently rendered visible by the application of electroscopic thermoplastic resin particles which are commonly referred to as toner. Specifically, photoreceptor 10 is charged on its surface by means of an electrical charger 12 to which a voltage has been supplied from power supply 11. The photoreceptor is then imagewise exposed to light from an optical system or an image input apparatus 13, such as a laser and light emitting diode, to form an electrostatic latent image thereon. Generally, the electrostatic latent image is developed by bringing a developer mixture from developer station 14 into contact therewith. Development can be effected by use of a magnetic brush, powder cloud, or other known development process.

After the toner particles have been deposited on the photoconductive surface, in image configuration, they are transferred to a copy sheet 16 by transfer means 15, which can be pressure transfer or electrostatic transfer. In embodiments, the developed image can be transferred to an intermediate transfer member and subsequently transferred to a copy sheet.

After the transfer of the developed image is completed, copy sheet 16 advances to fusing station 19, depicted in FIG. 1 as fusing and pressure rolls, wherein the developed image is fused to copy sheet 16 by passing copy sheet 16 between the fusing member 20 and pressure member 21, thereby forming a permanent image. Fusing may be accomplished by other fusing members such as a fusing belt in pressure contact with a pressure roller, fusing roller in contact with a pressure belt, or other like systems. Photoreceptor 10, subsequent to transfer, advances to cleaning station 17, wherein any toner left on photoreceptor 10 is cleaned therefrom by use of a blade 22 (as shown in FIG. 1), brush, or other cleaning apparatus.

Electrophotographic imaging members are well known in the art. Electrophotographic imaging members may be prepared by any suitable technique. Referring to FIG. 2, typically, a flexible or rigid substrate 1 is provided with an electrically conductive surface or coating 2.

The substrate may be opaque or substantially transparent and may comprise any suitable material having the required mechanical properties. Accordingly, the substrate may comprise a layer of an electrically non-conductive or conductive material such as an inorganic or an organic composition. As electrically non-conducting materials, there may be employed various resins known for this purpose including polyesters, polycarbonates, polyamides, polyurethanes, and the like which are flexible as thin webs. An electrically conducting substrate may be any metal, for example, aluminum, nickel, steel, copper, and the like or a polymeric material, as described above, filled with an electrically conducting substance, such as carbon, metallic powder, and the like or an organic electrically conducting material. The electrically insulating or conductive substrate may be in the form of an endless flexible belt, a web, a rigid cylinder, a sheet and the like. The thickness of the substrate layer depends on numerous factors, including strength desired and economical considerations. Thus, for a drum, this layer may be of substantial thickness of, for example, up to many centimeters or of a minimum thickness of less than a millimeter. Similarly, a flexible belt may be of substantial thickness, for example, about 250 micrometers, or of minimum thickness less than 50 micrometers, provided there are no adverse effects on the final electrophotographic device.

In embodiments where the substrate layer is not conductive, the surface thereof may be rendered electrically conductive by an electrically conductive coating 2. The conductive coating may vary in thickness over substantially wide ranges depending upon the optical transparency, degree of flexibility desired, and economic factors. Accordingly, for a flexible photoresponsive imaging device, the thickness of the conductive coating may be between about 20 angstroms to about 750 angstroms, or from about 100 angstroms to about 200 angstroms for an optimum combination of electrical conductivity, flexibility and light transmission. The flexible conductive coating may be an electrically conductive metal layer formed, for example, on the substrate by any suitable coating technique, such as a vacuum depositing technique or electrodeposition. Typical metals include aluminum, zirconium, niobium, tantalum, vanadium and hafnium, titanium, nickel, stainless steel, chromium, tungsten, molybdenum, and the like.

An optional hole blocking layer 3 may be applied to the substrate 1 or coating. Any suitable and conventional blocking layer capable of forming an electronic barrier to holes between the adjacent photoconductive layer 8 (or electrophotographic imaging layer 8) and the underlying conductive surface 2 of substrate 1 may be used.

An optional adhesive layer 4 may be applied to the hole-blocking layer 3. Any suitable adhesive layer well known in the art may be used. Typical adhesive layer materials include, for example, polyesters, polyurethanes, and the like. Satisfactory results may be achieved with adhesive layer thickness between about 0.05 micrometer (500 angstroms) and about 0.3 micrometer (3,000 angstroms). Conventional techniques for applying an adhesive layer coating mixture to the hole blocking layer include spraying, dip coating, roll coating, wire wound rod coating, gravure coating, Bird applicator coating, and the like. Drying of the deposited coating may be effected by any suitable conventional technique such as oven drying, infrared radiation drying, air drying and the like.

At least one electrophotographic imaging layer 8 is formed on the adhesive layer 4, blocking layer 3 or substrate 1. The electrophotographic imaging layer 8 may be a single layer (7 in FIG. 2) that performs both charge-generating and charge transport functions as is well known in the art, or it may comprise multiple layers such as a charge generator layer 5 and charge transport layer 6.

The charge generating layer 5 can be applied to the electrically conductive surface, or on other surfaces in between the substrate 1 and charge generating layer 5. A charge blocking layer or hole-blocking layer 3 may optionally be applied to the electrically conductive surface prior to the application of a charge generating layer 5. If desired, an adhesive layer 4 may be used between the charge blocking or hole-blocking layer 3 and the charge generating layer 5. Usually, the charge generation layer 5 is applied onto the blocking layer 3 and a charge transport layer 6, is formed on the charge generation layer 5. This structure may have the charge generation layer 5 on top of or below the charge transport layer 6.

Charge generator layers may comprise amorphous films of selenium and alloys of selenium and arsenic, tellurium, germanium and the like, hydrogenated amorphous silicon and compounds of silicon and germanium, carbon, oxygen, nitrogen and the like fabricated by vacuum evaporation or deposition. The charge-generator layers may also comprise inorganic pigments of crystalline selenium and its alloys; Group II-VI compounds; and organic pigments such as quinacridones, polycyclic pigments such as dibromo anthanthrone pigments, perylene and perinone diamines, polynuclear aromatic quinones, azo pigments including bis-, tris- and tetrakis-azos; and the like dispersed in a film forming polymeric binder and fabricated by solvent coating techniques.

Phthalocyanines have been employed as photogenerating materials for use in laser printers using infrared exposure systems. Infrared sensitivity is required for photoreceptors exposed to low-cost semiconductor laser diode light exposure devices. The absorption spectrum and photosensitivity of the phthalocyanines depend on the central metal atom of the compound. Many metal phthalocyanines have been reported and include, oxyvanadium phthalocyanine, chloroaluminum phthalocyanine, copper phthalocyanine, oxytitanium phthalocyanine, chlorogallium phthalocyanine, hydroxygallium phthalocyanine magnesium phthalocyanine and metal-free phthalocyanine. The phthalocyanines exist in many crystal forms, and have a strong influence on photogeneration.

Any suitable polymeric film forming binder material may be employed as the matrix in the charge-generating (photogenerating) binder layer. Typical polymeric film forming materials include those described, for example, in U.S. Pat. No. 3,121,006, the entire disclosure of which is incorporated herein by reference. Thus, typical organic polymeric film forming binders include thermoplastic and thermosetting resins such as polycarbonates, polyesters, polyamides, polyurethanes, polystyrenes, polyarylethers, polyarylsulfones, polybutadienes, polysulfones, polyethersulfones, polyethylenes, polypropylenes, polyimides, polymethylpentenes, polyphenylene sulfides, polyvinyl acetate, polysiloxanes, polyacrylates, polyvinyl acetals, polyamides, polyimides, amino resins, phenylene oxide resins, terephthalic acid resins, phenoxy resins, epoxy resins, phenolic resins, polystyrene and acrylonitrile copolymers, polyvinylchloride, vinylchloride and vinyl acetate copolymers, acrylate copolymers, alkyd resins, cellulosic film formers, poly(amideimide), styrenebutadiene copolymers, vinylidenechloride-vinylchloride copolymers, vinylacetate-vinylidenechloride copolymers, styrene-alkyd resins, polyvinylcarbazole, and the like. These polymers may be block, random or alternating copolymers.

The photogenerating composition or pigment is present in the resinous binder composition in various amounts. Generally, however, from about 5 percent by volume to about 90 percent by volume of the photogenerating pigment is dispersed in about 10 percent by volume to about 95 percent by volume of the resinous binder, or from about 20 percent by volume to about 30 percent by volume of the photogenerating pigment is dispersed in about 70 percent by volume to about 80 percent by volume of the resinous binder composition. In one embodiment, about 8 percent by volume of the photogenerating pigment is dispersed in about 92 percent by volume of the resinous binder composition. The photogenerator layers can also fabricated by vacuum sublimation in which case there is no binder.

Any suitable and conventional technique may be used to mix and thereafter apply the photogenerating layer coating mixture. Typical application techniques include spraying, dip coating, roll coating, wire wound rod coating, vacuum sublimation, and the like. For some applications, the generator layer may be fabricated in a dot or line pattern. Removing of the solvent of a solvent coated layer may be effected by any suitable conventional technique such as oven drying, infrared radiation drying, air drying and the like.

The charge transport layer 6 may comprise a charge transporting small molecule 22 dissolved or molecularly dispersed in a film forming electrically inert polymer such as a polycarbonate. The term “dissolved” as employed herein is defined herein as forming a solution in which the small molecule is dissolved in the polymer to form a homogeneous phase. The expression “molecularly dispersed” is used herein is defined as a charge transporting small molecule dispersed in the polymer, the small molecules being dispersed in the polymer on a molecular scale. Any suitable charge transporting or electrically active small molecule may be employed in the charge transport layer of this invention. The expression charge transporting “small molecule” is defined herein as a monomer that allows the free charge photogenerated in the transport layer to be transported across the transport layer. Typical charge transporting small molecules include, for example, pyrazolines such as 1-phenyl-3-(4′-diethylamino styryl)-5-(4″-diethylamino phenyl)pyrazoline, diamines such as N,N′-diphenyl-N,N′-bis(3-methylphenyl)-(1,1′-biphenyl)-4,4′-diamine, hydrazones such as N-phenyl-N-methyl-3-(9-ethyl)carbazyl hydrazone and 4-diethyl amino benzaldehyde-1,2-diphenyl hydrazone, and oxadiazoles such as 2,5-bis (4-N,N′-diethylaminophenyl)-1,2,4-oxadiazole, stilbenes and the like. However, to avoid cycle-up in machines with high throughput, the charge transport layer should be substantially free (less than about two percent) of di or triamino-triphenyl methane. As indicated above, suitable electrically active small molecule charge transporting compounds are dissolved or molecularly dispersed in electrically inactive polymeric film forming materials. A small molecule charge transporting compound that permits injection of holes from the pigment into the charge generating layer with high efficiency and transports them across the charge transport layer with very short transit times is N,N′-diphenyl-N,N′-bis(3-methylphenyl)-(1,1′-biphenyl)-4,4′-diamine (mTBD).

If desired, the charge transport material in the charge transport layer may comprise a polymeric charge transport material or a combination of a small molecule charge transport material and a polymeric charge transport material.

Any suitable electrically inactive resin binder insoluble in the alcohol solvent may be employed in the charge transport layer of this invention. Typical inactive resin binders include polycarbonate resin (such as MAKROLON), polyester, polyarylate, polyacrylate, polyether, polysulfone, and the like. Molecular weights can vary, for example, from about 20,000 to about 150,000. Examples of binders include polycarbonates such as poly(4,4′-isopropylidene-diphenylene)carbonate (also referred to as bisphenol-A-polycarbonate, poly(4,4′-cyclohexylidinediphenylene) carbonate (referred to as bisphenol-Z polycarbonate), poly(4,4′-isopropylidene-3,3′-dimethyl-diphenyl)carbonate (also referred to as bisphenol-C-polycarbonate) and the like. Any suitable charge transporting polymer may also be used in the charge transporting layer of this invention. The charge transporting polymer should be insoluble in the alcohol solvent employed to apply the overcoat layer of this invention. These electrically active charge transporting polymeric materials should be capable of supporting the injection of photogenerated holes from the charge generation material and be capable of allowing the transport of these holes there through.

Any suitable and conventional technique may be used to mix and thereafter apply the charge transport layer coating mixture to the charge generating layer. Typical application techniques include spraying, dip coating, roll coating, wire wound rod coating, and the like. Drying of the deposited coating may be effected by any suitable conventional technique such as oven drying, infrared radiation drying, air drying and the like.

Generally, the thickness of the charge transport layer is between about 10 and about 50 micrometers, but thicknesses outside this range can also be used. The hole transport layer should be an insulator to the extent that the electrostatic charge placed on the hole transport layer is not conducted in the absence of illumination at a rate sufficient to prevent formation and retention of an electrostatic latent image thereon. In general, the ratio of the thickness of the hole transport layer to the charge generator layers can be maintained from about 2:1 to 200:1 and in some instances as great as 400:1. The charge transport layer, is substantially non-absorbing to visible light or radiation in the region of intended use but is electrically “active” in that it allows the injection of photogenerated holes from the photoconductive layer, i.e., charge generation layer, and allows these holes to be transported through itself to selectively discharge a surface charge on the surface of the active layer.

In embodiments, an overcoat layer 7 is coated on the charge-transporting layer. In embodiments, the overcoat layer is prepared by combining in solution a prepolymer, melamine formaldehyde crosslinking agent, an acid catalyst, and a small molecule. In embodiments, the prepolymer comprises a reactive group selected from the group consisting of hydroxy, carboxylic acid and amide groups. The term “prepolymer” means a low molecular weight polymer that comprises reactive groups and forms a crosslinked polymer network when reacted with a crosslinking agent. Prepolymers are the result of reacting monomers to form very short polymers containing from about 5 to about 100 units. These products exhibit poor mechanical properties. Increasing chain length to from about 500 to about 1000 units is necessary to discover mature polymer properties. Crosslinked systems are different in that chain length cannot be determined due to insolubility of the system. Polymer chains are two dimensions, while crosslinking creates three dimensional networks. In embodiments, the prepolymer is low molecular weight polymer comprising hydroxyl, carboxylic acid, and/or amide groups. Commercially available examples of a prepolymer having reactive groups selected from the group consisting of hydroxy, carboxylic acid and amide groups, include hydroxy containing prepolymers such as JONCRYL® 510, JONCRYL® 580, JONCRYL® 587, and the like, available from Johnson Polymer, DESMOPHEN®, and the like from Bayer Chemical, and polyamides such as LUCKAMIDE® 5003, available from Dai Nippon Ink.

In embodiments, the prepolymer comprises from about 10 to about 50 percent solids, or from about 20 to about 40 percent solids, or about 32 percent solids. In embodiments, the prepolymer is diluted in a solvent such as tetrahydrofuran or Dowanol PM, or the like, or an alcohol selected from the group consisting of 1-methoxy-2-propanol, 2-butanol, 2-propanol, or the like. The solvent is added in an amount of from about 5 to about 50 percent solids, or from about 20 to about 35 percent solids, or about 16 percent solids.

Examples of melamine formaldehyde crosslinking agents include highly methylated melamine resins, such as those commercially available from Cytec Industries, such as CYMEL® 303, CYMEL® 104, CYMEL® MM-100, and the like. In embodiments, the crosslinking agent has from about 5 to about 40 percent solids by weight.

The reaction of these highly functionalized crosslinking agents with prepolymers can be catalyzed by the presence of a strong acid catalyst. Examples of acid catalysts include toluene sulfonic acid, and include commercially available acid catalysts from Cycat such as CYCAT® 600, CYCAT® 4040, and the like. In embodiments, the catalyst is added and reacted in an amount of from about 0.1 to about 5 percent, or from about 0.3 to about 3, or from about 0.4 to about 1 percent by weight of total solids.

A commercially available example of a prepolymer, melamine formaldehyde and acid catalyst mixture, is AR65-8, available from Film Coating Specialty, Incorporated.

In embodiments, the small molecule (18 in FIG. 2) is an alcohol-soluble small molecule. Examples include DHTPD (N,N′-diphenyl-N,N′-bis(3-hydroxyphenyl)-[1,1′-biphenyl]4-4′-diamine), In embodiments, the small molecule is added and reacted with the prepolymer and the melamine formaldehyde solution in an amount of from about 25 to about 60 percent by weigh of total polymer content.

In embodiments, the overcoat layer is a continuous overcoat layer and has a thickness of from about 0.1 to about 10 micrometers, or from about 1 to about 8 microns, or from about 2 to about 5 microns.

Any suitable or conventional technique may be used to mix and thereafter apply the overcoat layer coating mixture on the charge transport layer. Typical application techniques include spraying, dip coating, roll coating, wire wound rod coating, and the like. Drying of the deposited coating may be effected by any suitable conventional technique such as oven drying, infrared radiation drying, air drying, and the like. The dried overcoating should transport holes during imaging and should not have too high a free carrier concentration. Free carrier concentration in the overcoat increases the dark decay. In embodiments, the dark decay of the overcoated layer should be about the same as that of the uncoated, control device.

All the patents and applications referred to herein are hereby specifically, and totally incorporated herein by reference in their entirety in the instant specification.

The following Examples further define and describe embodiments of the present invention. Unless otherwise indicated, all parts and percentages are by weight.

### EXAMPLES

### Example 1

Preparation of Photogenerating Layer of Imaging Member

An imaging member was prepared by providing a 0.02 micrometer thick titanium layer coated on a biaxially oriented polyethylene naphthalate substrate (KALEDEX™ 2000) having a thickness of 3.5 mils. Applied thereon with a gravure applicator, was a solution containing 50 grams 3-amino-propyltriethoxysilane, 41.2 grams water, 15 grams acetic acid, 684.8 grams of 200 proof denatured alcohol and 200 grams heptane. This layer was then dried for about 5 minutes at 135° C. in the forced air drier of the coater. The resulting blocking layer (14) had a dry thickness of 500 Angstroms.

An adhesive layer (16) was then prepared by applying a wet coating over the blocking layer, using a gravure applicator, containing 0.2 percent by weight based on the total weight of the solution of copolyester adhesive (Ardel D100 available from Toyota Hsutsu Inc.) in a 60:30:10 volume ratio mixture of tetrahydrofuran/monochlorobenzene/methylene chloride. The adhesive layer was then dried for about 5 minutes at 135° C. in the forced air dryer of the coater. The resulting adhesive layer had a dry thickness of 200 angstroms.

A photogenerating layer dispersion was prepared by introducing-0.45 grams of Lupilon200® (PC-Z 200) available from Mitsubishi Gas Chemical Corp and 50 ml of tetrahydrofuran into a 4 oz. glass bottle. To this solution was added 2.4 grams of hydroxygallium phthalocyanine and 300 grams of ⅛ inch (3.2 millimeter) diameter stainless steel shot. This mixture was then placed on a ball mill for 20 to 24 hours. Subsequently, 2.25 grams of PC-Z 200 was dissolved in 46.1 gm of tetrahydrofuran, and added to this OHGaPc slurry. This slurry was then placed on a shaker for 10 minutes. The resulting slurry was, thereafter, applied to the adhesive interface with a Bird applicator to form a charge generation layer (18) having a wet thickness of 0.25 mil. However, a strip about 10 mm wide along one edge of the substrate web bearing the blocking layer and the adhesive layer, was deliberately left uncoated without any photogenerating layer material, to facilitate adequate electrical contact by the ground strip layer that was to be applied later. The charge generation layer was dried at 135° C. for 5 minutes in a forced air oven to form a dry charge generation layer having a thickness of 0.4 micrometer.

### Example 2

Coating with Transport Layer

Coating samples of Example I were coated with a transport layer (HTM) containing 50 weight percent (based on the total solids) of hole transport compound, N,N′-diphenyl-N,N′-bis(3-methyl-phenyl)-(1,1′-biphenyl)-4,4′-diamine.

In a four ounce brown bottle, 9.4 grams of MAKROLON® 5705 (available from Bayer Chemicals) was dissolved in 106 grams of methylene chloride. The solution was stirred with a magnetic bar. After the polymer was completely dissolved, 9.4 grams of N,N′-diphenyl-N,N′-bis(3-methylphenyl)-1,1′-biphenyl-4˜4′-diamine was added to the solution. The mixture was stirred overnight to assure a complete solution. The solution was applied onto the photogenerating layer made in Example 1 using a 4 mil Bird bar to form a coating. The coated devices were then heated in a forced air oven where the temperature was elevated from maintained at from about 40° C. to about 120° C. over a 30-minute period to form a charge transport layer having a dry thickness of 29 micrometers.

### Example 3

Preparation of Overcoat Layer

In a one ounce bottle was placed 1.34 grams of stock AR65-8 solution available from Film Specialty Inc., which contains about 0.4 grams of solids. This was combined with 0.4 grams N,N′-diphenyl-N,N′-bis(3-hydroxyphenyl)-[1,1′-biphenyl]-4,4′-diamine (DHTPD). The mixture was stirred until a complete solution was formed. The mixture was then diluted with 4 grams of Dowanol PM available from Dow Chemicals Company. The mixture has 50% DHTPD based on overall solids.

The solution was applied onto one of the samples from Example 2 using a 0.125 mil Bird bar to form a coating. The coated device was then heated in a forced air oven temperature was elevated from 40° C. to about 125° C. over a 30 minute period to form a cross-linked protective layer having a dry thickness of 3 micrometers.

### Example 4

Preparation of Overcoat Layer

A sample from Example 2 was overcoated with a protective layer coating solution as prepared in Example 3, except that the following substitutions were made. An amount of 0.31 grams N,N′-diphenyl-N,N′-bis (3-hydroxyphenyl)-(1,1′-biphenyl)-4,4′-diamine (DHTPD) was used. The mixture has 44% DHTPD based on overall solids.

### Example 5

Preparation of Overcoat Layer

A sample from Example 2 was overcoated with a protective layer coating solution as prepared in Example 3, except that the following substitutions were made. An amount of 0.23 grams N,N′-diphenyl-N,N′-bis (3-hydroxyphenyl)-(1,1′-biphenyl)-4,4′-diamine (DHTPD) was used. The mixture has 37% DHTPD based on overall solids.

### Example 6

Preparation of Overcoat Layer

One belt from Example 2 was overcoated with a protective layer coating solution as prepared in Example 3, except that the following substitutions were made. An amount of 0.2 grams N,N′-diphenyl-N,N′-bis (3-hydroxyphenyl)-(1,1′-biphenyl)-4,4′-diamine (DHTPD) was used instead of 0.4 grams. The mixture has 33% DHTPD based on overall solids. The solution was diluted with 1.34 grams of Dowanol PM.

### Example 7

Preparation of Overcoat Layer

One belt from Example 2 was overcoated with a protective layer coating solution as prepared in Example 3, except that the following substitutions were made. An amount of 0.16 grams N,N′-diphenyl-N,N′-bis (3-hydroxyphenyl)-(1,1′-biphenyl)-4,4′-diamine (DHTPD) was used. The mixture has 28% DHTPD based on overall solids instead. The solution was diluted with 1.34 grams of Dowanol PM.

### Example 8

Preparation of Overcoat Layer

One belt from Example 2 was overcoated with a protective layer coating solution as prepared in Example 3, except that the following substitutions were made. An amount of 0.23 grams N,N′-diphenyl-N,N′-bis (3-hydroxyphenyl)-(1,1′-biphenyl)-4,4′-diamine (DHTPD) was used. The mixture has 33% DHTPD based on overall solids. The solution was diluted with 1.34 grams of tetrahydrofuran.

### Example 9

Preparation of Overcoat Layer

One belt from Example 2 was overcoated with a protective layer coating solution as prepared in Example 3, except that the following substitutions were made. An amount of 0.04 grams (biphenyl-4-yl-bis-(3,4-dimethyl-phenyl)-amine (BPA) was used. The mixture has 5% BPA based on overall solids. The BPA was dissolved with 1.34 grams of tetrahydrofuran then added to the polymer solution.

### Example 10

Testing of Photoreceptor Sheets for Surface Potential After Exposure

The flexible photoreceptor sheets prepared as described in Examples 2 through 9 were tested for their xerographic sensitivity and cyclic stability in a scanner. In the scanner, each photoreceptor sheet to be evaluated was mounted on a cylindrical aluminum drum substrate, which was rotated on a shaft. The devices were charged by a corotron mounted along the periphery of the drum. The surface potential was measured as a function of time by capacitively coupled voltage probes placed at different locations around the shaft. The probes were calibrated by applying known potentials to the drum substrate. Each photoreceptor sheet on the drum was exposed to a light source located at a position near the drum downstream from the corotron. As the drum was rotated, the initial (pre-exposure) charging potential was measured by voltage probe 1. Further rotation lead to an exposure station, where the photoreceptor device was exposed to monochromatic radiation of a known intensity. The devices were erased by a light source located at a position upstream of charging. The measurements illustrated in Table 1 below include the charging of each photoconductor device in a constant current or voltage mode. The devices were charged to a negative polarity corona. The surface potential after exposure was measured by a second voltage probe. The devices were finally exposed to an erase lamp of appropriate intensity and any residual potential was measured by a third voltage probe. The process was repeated with the magnitude of the exposure automatically changed during the next cycle. The photodischarge characteristics were obtained by plotting the potentials at voltage probe 2 as a function of light exposure.

TABLE 1

| | | | Background | Background | Stability |
|---|---|---|---|---|---|
| | Sensitivity | Sensitivity | at 6 ergs | at 6 ergs | of |
| | at 0k | at 10k | 0k | 10k | Back- |
| Example | cycle | cycles | cycle | cycles | ground |
| 2 | 347 | 398 | 41 | 83 | 42 |
| 3 | 386 | 368 | 49 | 54 | 5 |
| 4 | 341 | 345 | 52 | 57 | 5 |
| 5 | 335 | 350 | 58 | 62 | 4 |
| 6 | 311 | 316 | 61 | 65 | 4 |
| 7 | 313 | 317 | 60 | 62 | 2 |
| 8 | 347 | 343 | 106 | 96 | −10 |
| 9 | 335 | 338 | 104 | 92 | −12 |

### Example 11

Testing of Photoreceptor for Lateral Charge Migration Caused by Corona Charging

Hand-coated samples of the formulations described in Examples 2 through 9 were cut into small sheets (1.5 inches×11 inches) and wrapped around a 84 mm photoreceptor drum. This drum with the sample belt wrapping around it was then exposed to corona effluents generated from a charging device. After being exposed for 30 minutes, using a DC 12 Limoges printer, the drum was printed with a target containing various types of bit lines for LCM deletion. The target print has 5 different bit lines ranging from 1 bit to 5 bit. FIG. 3 shows the effect of corona effluents on LCM for all the formulations of the invention and the comparative formulation. The sample with the least number of visible lines was badly affected by corona effluents and completely deleted if there were no visible lines. The comparative formulation (Example 2) was badly deleted after 30 minutes exposure to corona, whereas all of the formulations of the invention are not substantially affected by LCM deletion. With 0 being without any deletion and 6 being the worst sample, the comparative formulation has a grade of 6.

### Example 12

Testing of Photoreceptor for Mechanical Cracks Caused by Solvent Vapor

Hand-coated samples of Examples 2 through 9 were cut into small sheets as above and wrapped around two 0.5 inch diameter rods. One rod was exposed to a solvent vapor mixture of 3.73% i-propanol alcohol, 2.76% TEA (tri-ethanol amine), and 93.5% water in a sealed container for 6 days. Cracks on the photoreceptor belts were visualized by human eyes under an appropriate lighting system. With 0 being without any crack and 6 being the worst cracked sample, the comparative formulation (example 2) had a grade of 5, and samples from Example 3 to 9 had grades between 0 and 2.

### Example 13

Testing of Photoreceptor for Mechanical Cracks Caused by Corona Effluent

The second rod was exposed to corona effluents inside a large glass tub for 12 hours. The charging system was setup at 400 mA and 7000 V. Under the same grading system as above, the comparative formulation shows a cracking grade of 4 whereas all formulations of the invention from examples 2 to 7 are found without any crack and graded with 0.

### Example 14

Testing of Photoreceptor for Machine Cracks Caused by Breakdown of Mechanical Strength of the Charge Transport Layer

Hand-coated samples of Examples 2 through 7 were cut into small sheets as above and were flexed in a tri-roller flexing system. Each belt was under a 1.1 lb/inch tension and each roller was 0.5 inches in diameter. The belts were flexed for 10 k cycles before being exposed to corona effluent for 15 minutes. Flexing life of a belt was defined as the number of cycles that the first delaminated crack is visualized. The printable cracks occurred at the charge transport layer and ended at the interface with the substrate. While the comparative formulation (example 2) and formulations of Example 3 and 4 had the similar cracking life. Samples from example 5 to 7 showed great improvement in extending photoreceptor life over comparative formulation.

### Example 15

Testing of Photoreceptor for Scratches Caused by Debris and Spots Blade

Hand-coated samples of Examples 2 through 7 were cut into small sheets as above and were flexed in a tri-roller flexing system. Each belt was under a 1.1 lb/inch tension and each roller was 0.5 inches in diameter. A polyurethane spots blade was placed in contact with each belt at an angle between 5 to 15 degrees. Carrier beads of about 100 micrometers in size were attached to the spots blade by the aid of a double tape. Belts were flexed for 7,000 cycles. Depth of the scratches caused by carrier beads were studied by analyzing the roughness profile of each sample. While the comparative formulation (Example 2) and formulations of Example 3 and 4 had the similar scratching profile, samples from Examples 5 to 9 showed great improvement in extending photoreceptor scratching life over comparative formulation.

While the invention has been described in detail with reference to specific and embodiments, it will be appreciated that various modifications and variations will be apparent to the artisan. All such modifications and embodiments as may readily occur to one skilled in the art are intended to be within the scope of the appended claims.

What is claimed is:

1. A process for preparing an overcoat for an imaging member, said imaging member comprising a substrate, a charge transport layer, and an overcoat positioned on said charge transport layer, wherein said process comprises:
a) adding and reacting a prepolymer comprising a reactive group selected from the group consisting of hydroxyl, carboxylic acid and amide groups, a melamine formaldehyde crosslinking agent, an acid catalyst, and an alcohol-soluble small molecule to form an overcoat solution; and
b) subsequently providing said overcoat solution onto said charge transport layer to form an overcoat layer.

2. A process in accordance with claim 1, wherein said reactive group is a hydroxy group.

3. A process in accordance with claim 2, wherein said prepolymer is a polyamide.

4. A process in accordance with claim 1, wherein said prepolymer comprises from about 10 to about 50 percent solids

5. A process in accordance with claim 4, wherein said prepolymer comprises from about 20 to about 40 percent solids.

6. A process in accordance with claim 1, wherein said prepolymer comprises about 32 percent solids.

7. A process in accordance with claim 1, wherein said prepolymer is diluted in a solvent prior to adding and reacting in step (a).

8. A process in accordance with claim 7, wherein said solvent is selected from the group consisting of 1-methoxy-2-propanol, 2-butanol and 2-propanol.

9. A process in accordance with claim 8, wherein said solvent is in an amount of from about 5 to about 50 percent solids.

10. A process in accordance with claim 9, wherein said solvent is in an amount of from about 20 to about 35 percent solids.

11. A process in accordance with claim 1, wherein said small molecule is (N,N′-diphenyl-N,N′-bis(3-hydroxyphenyl)-[1,1′-biphenyl]-4-4′-diamine).

12. A process in accordance with claim 1, wherein said charge transport layer comprises a polycarbonate.

13. A process in accordance with claim 12, wherein said charge transport layer further comprises N,N′-diphenyl-N,N′-bis(3-methyl-phenyl)-(1,1′-biphenyl)-4,4′-diamine.

14. A process in accordance with claim 1, wherein said overcoat solution is provided onto said charge transport layer to a dried thickness of from about 0.1 to about 10 micrometers.

15. A process in accordance with claim 14, wherein said overcoat solution is provided onto said charge transport layer to a dried thickness of from about 1 to about 8 microns.

16. A process for preparing an overcoat for an imaging member, said imaging member comprising a substrate, a charge transport layer, and an overcoat positioned on said charge transport layer, wherein said process comprises:
a) combining a polyamide prepolymer, a melamine formaldehyde crosslinker, an acid acceptor, and an alcohol-soluble small molecule to form an overcoat solution; and
b) subsequently providing said overcoat solution onto said charge transport layer to form an overcoat layer.

17. A process in accordance with claim 16, wherein said charge transport layer comprises polycarbonate.

18. A process for preparing an overcoat for an imaging member, said imaging member comprising a substrate, a charge transport layer comprising a polycarbonate and N,N′-diphenyl-N,N′-bis(3-methyl-phenyl)-(1,1′-biphenyl)-4,4′-diamine, and an overcoat positioned on said charge transport layer, wherein said process comprises:
a) combining a prepolymer comprising a reactive group selected from the group consisting of hydroxyl, carboxylic acid, and amide groups, a melamine formaldehyde crosslinking agent, an acid catalyst, and an alcohol-soluble small molecule to form an overcoat solution; and
b) subsequently providing said overcoat solution onto said charge transport layer to form an overcoat layer.
